(19) United States
(12) Patent Application Publication
(10) Pub. No.: US 2005/0251766 A1
(43) Pub. Date: Nov. 10, 2005

(54) Circuit design interface

(76) Inventors: Gaurav R. Shah, Caldwell, ID (US); Denise S. Man, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/089,572

(22) Filed: May 7, 2004

(51) Int. Cl. G06F 17/50

(52) U.S. Cl. 716/4; 716/7; 716/11; 703/16

(57) ABSTRACT

According to an example embodiment of an approach to circuit design processing involves using an interface for retrieving and processing circuit design data for use by a plurality of simulation tools. The interface includes an application program callable function configured to return functional classification data in response to an application programming interface (API) call from a simulation tool. The API call specifies a design block identifier that is used by the application program callable function to search a data source for functional classification data associated with the design block identifier. If functional classification data associated with the design block identifier is not found in the data source, a plurality of circuit elements associated with the design block identifier is retrieved from a netlist. A functional classification of the plurality of circuit elements is determined and functional classification data indicative of the functional classification is associated with the design block identifier and stored in the data source. Functional classification data associated with the design block identifier is also returned to the simulation tool.

### BACKGROUND

Circuit designs are generally created and implemented using tools that generate circuit design information that is stored in one or more data storage arrangements. This information may be accessed for analysis and testing (e.g., simulation) by a variety of tools. These tools often successively and/or simultaneously access this information for a variety of analysis and testing purposes.

Access to the stored circuit design information for simulation typically requires that retrieved data be processed, with certain characteristics useful to the simulation being identified. Specifically, design information is read in a form that is amenable to database-type storage and subsequently processed to generate information that is useful for further analysis and testing.

In this regard, when different tools need to access the same data for analysis and testing purposes, each tool processes and stores the data in another format. At times, the processing approaches at different tools vary. In addition, processing the design data in this manner can be time consuming and otherwise complex. Furthermore, as circuit designs become larger and more complex, the amount of memory needed to store formatted data for analysis and testing purposes becomes increasingly large.

### SUMMARY

According to an example embodiment of the present invention, an interface is adapted for retrieving and processing circuit design data for use by a plurality of simulation tools. The interface includes an application program callable function that is configured to respond to an application programming interface (API) call from a simulation tool that specifies a design block identifier by returning functional classification data for the design block. The application program callable function is adapted to search a data source for functional classification data associated with the design block identifier. If functional classification data for the design block identifier is not in the data source, the application program callable function retrieves, from a netlist, a plurality of circuit elements associated with the design block identifier. The application program callable function then determines a functional classification of the plurality of circuit elements and stores, in the data source, data indicative of the functional classification in association with the design block identifier. The functional classification data associated with the design block identifier is also returned to the simulation tool by the application program callable function.

It will be appreciated that various other embodiments are set forth in the Detailed Description and Claims that follow.

### BRIEF DESCRIPTION OF THE DRAWINGS

FIG. 1 shows a flow diagram for an approach to processing circuit design data, according to an example embodiment of the present invention;

FIG. 1A shows a flow diagram for another approach to processing circuit design data, according to another example embodiment of the present invention;

FIG. 1B shows a flow diagram for another approach to processing circuit design data, according to another example embodiment of the present invention

FIG. 2 shows a circuit recognition engine (CRE) interface configured and arranged for interfacing with a plurality of simulation tools and a database for circuit recognition, according to another example embodiment of the present invention; and

FIG. 3 shows a system for circuit design simulation, according to another example embodiment of the present invention.

### DETAILED DESCRIPTION

According to an example embodiment of the present invention, circuit design information is processed, stored and made available for a plurality of simulation tools. When a particular simulation tool requests access to information regarding a component of a circuit design, information regarding the design component is retrieved, processed and stored in a format that is amenable to simulation. At least a portion of the processed information is also returned to the simulation tool and/or made available for rapid access by the simulation tool. When a second simulation tool requests access to information regarding the design component, the stored design component information is returned to the second simulation tool.

In one particular example, a circuit design is initially stored in the form of a netlist. An identifier (e.g., name and path) of a particular block of the design is specified in an application program interface (API) call by a simulation tool and the block (corresponding to the identifier is retrieved from the netlist. The retrieved block is processed to generate a functional classification of the block that describes a function performed by a combination of circuit components in the block (or, in some instances, by the entire block itself)). The functional classification of the block is returned to the simulation tool and stored in a data storage arrangement in association with the identifier, where it is available for access by other simulation tools.

In another example embodiment of the present invention, a circuit recognition engine (CRE) interface facilitates data transfer between a multitude of simulation nodes and a database implemented for storing processed circuit design information. Simulation as discussed herein may involve, for example, one or more of determining the type of circuits in the design, determining connectivity of circuits in the design, determining functional characteristics of the design, running test signals on the design or otherwise verifying characteristics of the design.

When an API call specifies an identifier for a circuit design block to be retrieved, the CRE interface retrieves the circuit design block associated with the identifier from a netlist. The netlist typically includes a hierarchical classification of the circuit design that includes blocks and nets, the blocks including one or more circuit elements and the nets describing the interconnection of the circuit elements and/or blocks. This hierarchical classification in the netlist typically does not describe any grouping of the interconnected circuit elements that make up functional circuits (e.g., well-known circuits such as inverters, or customer-specific circuits). In this regard, the CRE interface processes the circuit design block to functionally classify the block or components thereof. The functional classification describes functional characteristics of groups of circuit elements in the block when implemented together in a manner that is useful for simulating the circuit design block.

Information regarding the functional circuit classification is returned to a simulation node sending the API call for the particular circuit design block. In some instances, the entire functional circuit classification of a circuit design block is returned to the simulation node. In other instances, a functional circuit classification for selected portions of the circuit design block are returned to the simulation node as a function of a subsequent API call. In still other instances, some or all of the functional circuit classification is stored in a local memory at the CRE interface in association with an identifier for the block to which the functional classification applies. This stored functional circuit classification is associated with the design block identifier and made available for selective access by simulation nodes (e.g., via the CRE interface).

In some implementations, the CRE interface arrangement interacts with a circuit recognition database (CRD) for storing and retrieving functional circuit classification data for circuit design blocks. The CRD may be implemented using, e.g., XML (extensible markup language), SQL (structured query language) or one of various other data storage arrangements/approaches. In addition, the CRD can be implemented either locally at the CRE interface arrangement or remotely, with access to the CRD being via one or more of a variety of communication links. For instance, the CRD may be coupled to network communications link, such as an Internet protocol (IP) link, with the CRD being assigned an address (e.g., an IP address) used by the CRE interface arrangement for interacting with the CRD.

When a particular circuit design block is requested by a simulation node, the CRE interface arrangement retrieves information for the circuit design block (e.g., from a netlist) and creates a functional circuit classification for the circuit design block. The functional circuit classification is then stored at the CRD and associated with an identifier for the circuit design block. When subsequent API calls specifying the design block identifier are received at the CRE interface arrangement, the functional circuit classification associated with the identifier is retrieved from the CRD and returned to the simulation node making the subsequent API call.

In another implementation, the CRE interface is programmed to manage updates to circuit design information to ensure that information stored at the CRD is up to date. To ensure that information is up to date, logical circuit classification data stored at the CRD is manipulated as a function of corresponding information in a netlist used in generating the functional circuit classification data. For instance, when a particular circuit design block having its functional circuit classification stored at the CRE interface is updated in the netlist, the information at the CRE interface becomes outdated. In this regard, when an API call for the circuit design block is made, the CRE interface arrangement checks the netlist to see if information for the circuit design block has been updated in the netlist. This API call and check of the netlist may be implemented, for instance, using an identifier for the circuit design block; corresponding information for the circuit design block in both the CRD and the netlist is associated with the identifier. If information for the circuit design block in the netlist has not been updated, the CRE interface arrangement returns functional circuit classification data stored at the CRD. However, if the information for the circuit design block in the netlist has been updated, the CRE interface discards outdated information in the CRD. The updated circuit design block is then retrieved from the netlist and a new functional circuit classification is generated from the updated circuit design block (i.e., circuit recognition is again performed on the updated circuit design block). Information regarding this new functional circuit classification is returned to the simulation node making the API call and further stored in the CRD.

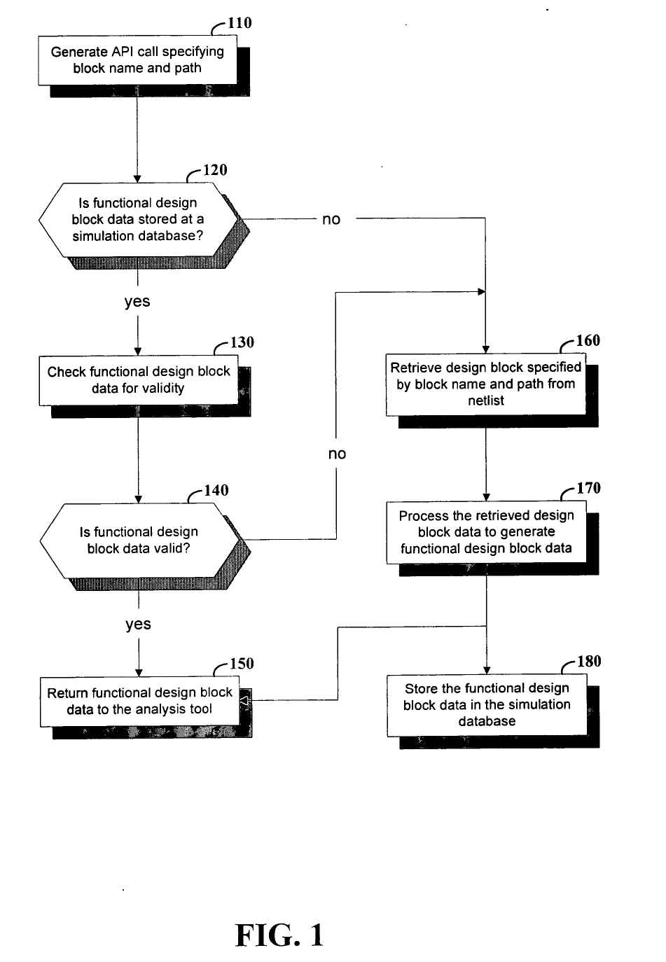

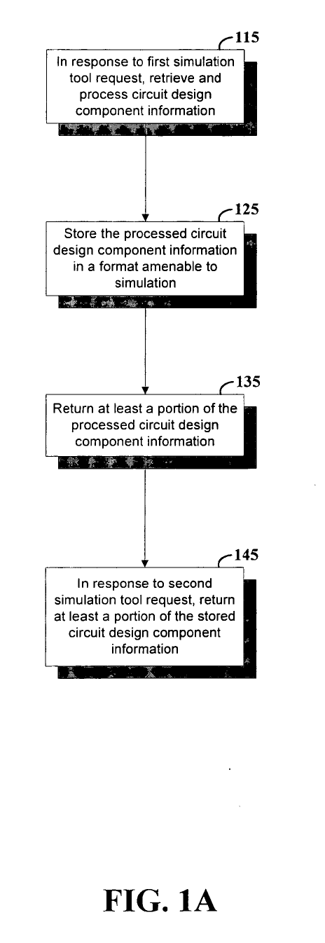

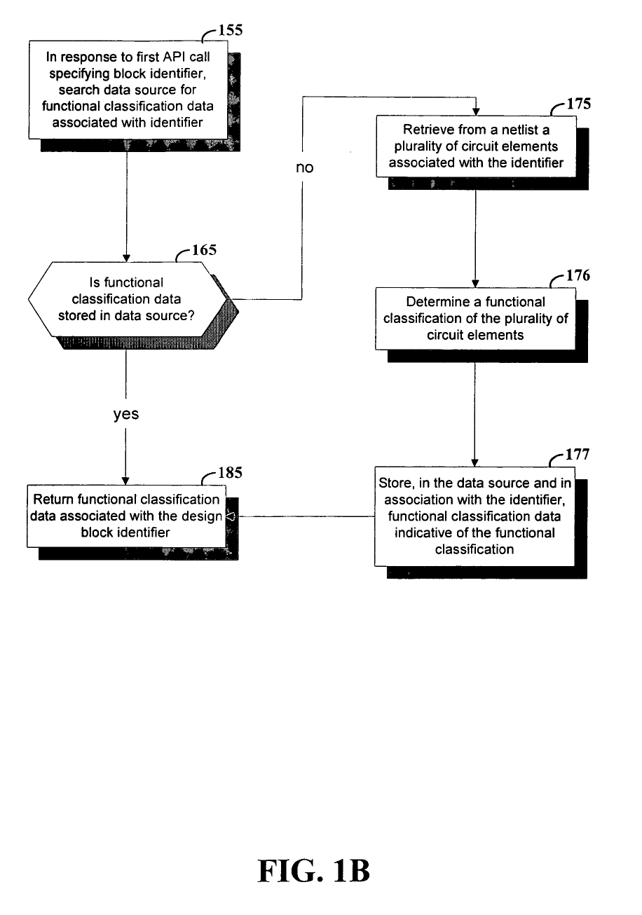

Turning now to the figures, FIG. 1 shows an approach for simulating (i.e., analyzing/testing) circuit design data, according to another example embodiment of the present invention. At block 110, a simulation tool generates an API call specifying a design block identifier for retrieving functional design block data (i.e., data describing the functional operation of the block). If the design block has corresponding functional design block data stored in a simulation database at block 120, the functional design block data is checked for validity at block 130 using one or more of a variety of approaches. In one instance, a date characteristic of the functional design block data is compared with a corresponding date characteristic of the design block data in a netlist from which the design block data was retrieved. If the functional design block data is valid at block 140, it is returned to the simulation tool at block 150.

If functional design block data for the design block specified by the API call is not stored in the simulation database at block 120, the specified design block is retrieved from the netlist at block 160. Similarly, the specified design block is also retrieved from the netlist at block 160 if the functional design block data is found to be invalid at block 130. In either instance, the retrieved design block is processed at block 170 to generate a functional design block data describing functional characteristics of the block and that is amenable to simulation. The design block processing may involve, for example, processing netlist information to generate data that represents the functional circuit classification of one or more combinations of circuit elements in the netlist for the design block. The classification data is generated, for example, by identifying a combination of circuit elements in the design block as corresponding to a particular known circuit or as having known circuit properties. The functional design block data is returned to the simulation tool at block 150 and further stored in the simulation database at block 180 for use with subsequent API calls.

FIG. 1A shows a flow diagram for another approach to processing circuit design data, according to another example embodiment of the present invention. At block 115, circuit design component information is retrieved and processed in response to a first simulation tool request. The processed circuit design component information is stored at block 125 and at least a portion of the processed circuit design component information is returned (i.e., to a requesting tool) at block 135. When a second simulation tool request is received at block 145, at least a portion of the stored circuit design component information is returned.

FIG. 1B shows another flow diagram for an approach to processing circuit design data, according to another example embodiment of the present invention. In response to a first API call specifying a design block identifier at block 155, a data source is searched for functional classification data associated with the identifier. If the functional classification data associated with the identifier is not stored in a data source at block 165, a plurality of circuit elements associated with the identifier are retrieved at block 175. A functional classification of the plurality of circuit elements is determined at block 176. Functional classification data indicative of the determined functional classification data is then stored in the data source and in association with the identifier at block 177. If functional classification data is stored in the data source at block 165 (or after such data has been stored at block 177), functional classification data associated with the design block identifier is returned (i.e., to the source of the API call) at block 185.

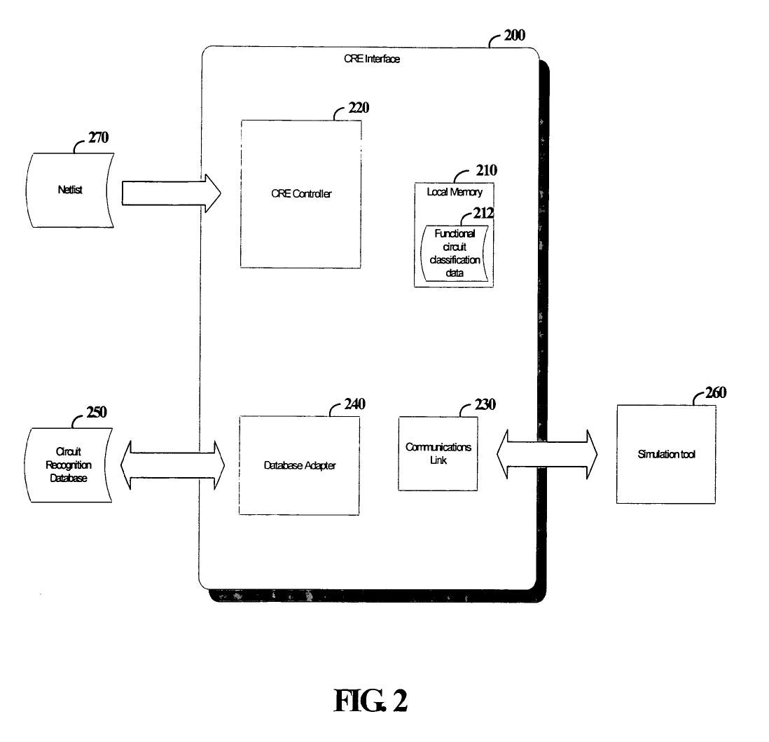

FIG. 2 shows a circuit recognition engine (CRE) interface 200 configured and arranged for interfacing with a plurality of simulation tools for circuit recognition, according to another example embodiment of the present invention. The CRE interface 200 includes a local memory 210, a CRE controller 220, a communications link 230 and a database adapter 240. Requests (API calls) for circuit design block information received via the communications link 230 are processed and corresponding functional circuit design block information is returned to the application tool making the request. The functional circuit design block information typically includes functional circuit classification data for the requested circuit design block or for a portion thereof (represented, e.g., by functional circuit classification data 212).

One particular application of the CRE interface 200 is as follows. When a simulation tool 260 needs circuit design block data, it sends an API call specifying a circuit design block identifier (i.e., a block name and file system path indicating where to find the block) to the CRE controller 220. An application program callable function in the CRE controller 220 responds to the API call by perusing a CRD 250 (using database adapter 240) for functional circuit classification data associated with the design block identifier. This application program callable function (and other similar ones discussed herein) may be implemented, for example, with two or more callable functions for performing different functions in response to the API call. If the functional circuit classification data is in the CRD 250, the database adapter 240 retrieves the functional circuit classification data, which is returned to the simulation tool 260 making the API call via the communications link 230. In some instances, this return of functional circuit classification data involves storing the data in the local memory 210, with the simulation tool 260 selectively accessing the stored data.

When circuit design block information specified by an API call is not in the CRD 250, the CRE controller 220 retrieves information for the specified circuit design block from a netlist 270. The CRE controller 220 analyzes the retrieved circuit design block information and generates functional circuit classification data that describes (e.g., classifies into one or more categories) the functionality of a combination of some or all circuit elements in the circuit design block. This classification may involve, for example, comparing the retrieved combination of circuit elements with known circuit element combinations and classifying the retrieved combination of circuit elements with the name of a matching known combination. For instance, user-defined classifications can be programmed into (or otherwise accessible by) the CRE interface 200, with matching combinations of circuit elements being classified with user-defined classification names.

In some implementations, the CRE controller 220 is further adapted to combine selected circuit elements in retrieved design blocks to create functional circuits (e.g., known circuits having a name and properties, such as an inverter). Rules for combining the selected circuit elements can be stored at the CRE interface 200 or accessed remotely. Once circuit elements are combined to create the functional circuits, the CRE controller classifies the functional circuits by identifying the functional circuits with a name and/or property associated with a corresponding known circuit.

The CRE controller 220 stores the generated functional circuit classification data at the CRD 250 and, depending upon the content of the API call, some or all of the stored data is returned to the simulation tool 260. In some instances, the functional circuit classification data is stored in the local memory 210 in association with the circuit design block identifier, from which the data can be returned to the simulation tool 260.

In some instances, the CRE controller 220 is programmed to automatically check for updates to circuit design blocks having corresponding (functional) data stored in the CRD 250. For example, when a circuit design block having functional circuit classification data stored in the CRD 250 is the subject of an API call, the CRE controller 220 checks for updates to the circuit design block. This checking approach may involve, for example, comparing a date stamp of data in the CRD 250 with the current date stamp of the circuit design block in the netlist from which the data was created. If functional circuit classification data in the CRD 250 is current, the data is returned via the communications link 230 to the simulation tool making the API call. If the functional circuit classification data in the CRD 250 is not current, the CRE controller 220 retrieves circuit design block data from the netlist 270. The retrieved circuit design block data is analyzed to generate a functional circuit classification of the circuit design block specified in the API call. Outdated logical circuit classification data in the CRD 250 can then be overwritten with the newly-formatted circuit design block data, discarded or otherwise marked as out of date.

In one implementation, the database adapter 240 interfaces with different types of data sources (implemented as the CRD 250) for storing and retrieving functional circuit classification data. Functional circuit classification data retrieved from the CRD 250 is processed and stored in the local memory 210 (or passed to the simulation tool 260) in a format that is accessible by a plurality of simulation tools. In addition, the format of the processed functional circuit classification data is generally independent from the data source from which the data is retrieved. For general information regarding design data retrieval and for specific information regarding an interface approach involving selective access to different types of data sources to which the present invention is applicable, reference may be made to U.S. patent application Ser. No. ______ (200209788-1/HPCO.131PA) entitled “Circuit Design Interface” and filed on Feb. 24, 2004, which is fully incorporated herein by reference.

In another implementation, the CRE controller 220 is adapted to retrieve certain portions of a circuit design block when functional classifications of other portions of the circuit design block are stored at the CRD 250. For example, where functional classification data for certain sub-blocks of a parent block that is the subject of an API call is stored in the CRD 250, functional classification data for those sub-blocks does not necessarily need to be generated. In this regard, the CRE controller 220 retrieves (from the netlist 270) sub-blocks not having functional classification data in the CRD 250 and processes the retrieved sub-blocks to generate functional classification data that describes the sub-blocks. The functional classification data generated for the retrieved sub-blocks is then stored in the CRD 250 along with functional classification data for other sub-blocks of the parent block. Functional classification data for the entire parent block is then accessible by the CRE controller 220 for use in response to the API call and subsequent API calls to the parent block (or portions thereof), as discussed above.

In still another implementation, the CRE interface 210 is adapted for writing data to a design (e.g., for correcting portions of the design). For example, when a particular circuit design block is being simulated at the simulation tool 260 and an error is discovered, it is sometimes desirable to store design data (or functional classification data) that corrects the error. Such a correction may involve, for example, a replacement, configuration or other change to circuitry as represented by the design data. This corrected design data can be entered at the simulation tool 260 or another type of user tool and communicated to the CRE interface 210 for use by other simulation tools. In some instances, the CRE controller 220 causes the corrected design data (or functional data) to be written to the CRD 250 and, in other instances, to the netlist 270. When updated data is written to the netlist 270, any data in the CRD 250 (or other CRDs that interact with the netlist 270) relating to the written data is out of date. In this regard, the out of date data in the CRD 250 (or other database) is overwritten upon requested access to the data, as discussed above.

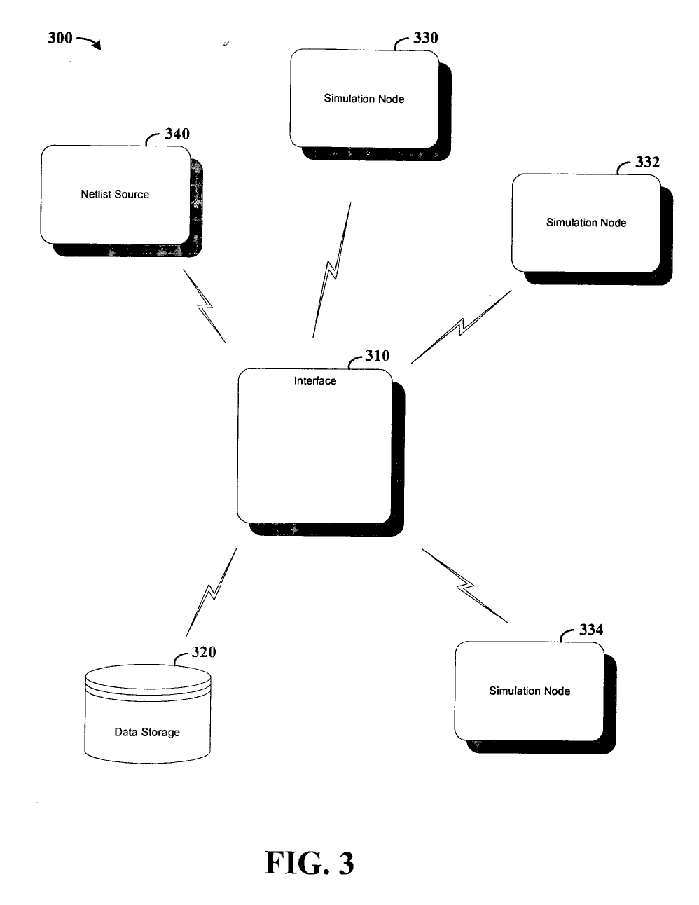

FIG. 3 shows a system 300 for circuit design simulation, according to another example embodiment of the present invention. The system 300 includes an interface 310, a data storage arrangement 320 and a plurality of simulation nodes including nodes 330, 332 and 334. Each of these simulation nodes includes a tool for simulating circuit design data and a communications link for communicating with the interface 310. The data storage arrangement 320 stores design information for one or more particular circuit designs in a particular language associated with the data storage arrangement, such as XML or SQL. The interface 310 functions to retrieve and process circuit design information from a netlist source 340 to generate functional classification data that describes the functionality of one or more groups of circuit elements in the circuit design. The interface 310 stores the functional classification data for the circuit design in the data storage arrangement 320 for use by simulation tools. The interface 310 may, for example, be implemented using one or more of the approaches discussed in connection with FIG. 2 above.

The simulation nodes 330, 332 and 334 include one or more of a variety of simulation tools adapted for analyzing circuit designs. These tools may be implemented for simulation approaches involving, for example, one or more of: electrical rules checking (ERC), power estimation and timing for a particular circuit design or circuit design component. In addition, one or more of simulation nodes 330, 332 and 334 may include a user interface adapted for receiving input data from users for controlling and monitoring the simulation of circuit designs.

In one implementation, the data storage arrangement 320 includes two or more data storage arrangements. These data storage arrangements may, for example, be coupled to the interface 310 via a network or other readily accessible communications link. The interface 310 is correspondingly adapted to retrieve data from different data source types using, for example, separate adapters tailored for use with a particular type of data source. This approach may be implemented, for example, in a manner similar to that discussed in connection with U.S. patent application Ser. No. ______ entitled “Circuit Design Interface,” referenced above.

In another implementation, one or more of the simulation nodes 330, 332 and 334 include some or all of the functionality of the interface 310 and/or the data storage arrangement 320. For example, if the simulation node 330 includes the interface 310, the other nodes 332 and 334 communicate with the simulation node 330 for circuit design simulation. In this regard, API calls for a particular block are made via simulation node 330, which returns functional classification data for the requested block from the data storage arrangement 320 (when available). If functional classification data for the requested block is not available in the data storage arrangement 320 (or if data is outdated), the simulation node 330 accesses the requested block (or portions thereof) from the netlist source 340. The simulation node functionally classifies the requested block and stores the result. Subsequent access to the information by the other simulation nodes 332 and 334 is made via simulation node 330.

In still another implementation, two or more of the simulation nodes 330, 332 and 334 include memory for storing formatted design data. Using simulation node 330 as an example, when functional information for a circuit design is to be retrieved, the simulation node sends a request for the circuit design. Each of the simulation nodes is perused to check for functional classification data for the requested circuit design. If the functional classification data for the requested circuit design exists (and is up to date, if update checking is implemented as discussed above), the data is returned to the simulation node 330. If none of the simulation nodes has functional classification data for the requested circuit design (or if available formatted data is invalid), the simulation node 330 accesses requested information via the interface 310.

Those skilled in the art will appreciate that various alternative computing arrangements would be suitable for hosting the processes of the different embodiments of the present invention. In addition, the processes may be provided via a variety of computer-readable media or delivery channels such as magnetic or optical disks or tapes, electronic storage devices, or as application services over a network.

The present invention is believed to be applicable to a variety of circuit design processing arrangements and approaches and has been found to be particularly applicable and beneficial in re-using processed design data for multiple simulation tools. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. An interface for retrieving and processing circuit design data for use by a plurality of simulation tools, the interface comprising:
an application program callable function configured to:
in response to an application programming interface (API) call from a simulation tool that specifies a design block identifier, search a data source for functional classification data associated with the design block identifier;
in response to functional classification data for the design block identifier not being in the data source, retrieve from a netlist a plurality of circuit elements associated with the design block identifier, determine a functional classification of the plurality of circuit elements and store, in the data source and in association with the design block identifier, functional classification data indicative of the functional classification; and
return functional classification data associated with the design block identifier to the simulation tool.

2. The interface of claim 1, wherein the application program callable function is configured to determine a functional classification of a combination of the plurality of circuit elements by identifying the combination as making up a particular functional circuit and assigning a property to the combination that characterizes the particular functional circuit.

3. The interface of claim 1, wherein the application program callable function is further configured to access functional classification data that describes a functional classification of selected combinations of circuit elements and to functionally classify the retrieved circuit elements based on the accessed functional classification data.

4. The interface of claim 3, wherein the application program callable function is further configured to functionally classify the retrieved circuit design data by comparing a combination of the retrieved circuit elements with a set of classified combinations of circuit elements and, in response to finding a match between the combination of the retrieved circuit elements and one of the classified combinations of circuit elements, determine the functional classification of the combination of the retrieved circuit elements by classifying the combination of retrieved circuit elements with the classification of the matching classified combination of circuit elements.

5. The interface of claim 1, further comprising a memory arranged to store functional classification data for a set of circuits, the application program callable function being further configured to determine a functional classification of the plurality of circuit elements based on the stored functional classification data.

6. The interface of claim 1, wherein the application program callable function is further configured to return functional classification data associated with the design block identifier to the simulation tool by retrieving the functional classification data from the data source and sending the retrieved functional classification data to the simulation tool.

7. The interface of claim 1, wherein the application program callable function is further configured to return functional classification data associated with the design block identifier to the simulation tool by retrieving the functional classification data from the data source and storing the retrieved functional classification data in a local memory, and wherein the interface further comprises a second application program callable function configured to return functional classification data for a selected portion of the design block to the simulation tool in response to a call to the second application program callable function that specifies the selected portion of a design block.

8. The interface of claim 1, wherein the application program callable function is further configured to, in response to functional classification data for the design block identifier being in the data source, access the functional classification data for the design block identifier in the data source and return the accessed data to the simulation tool.

9. The interface of claim 1, wherein the application program callable function is further configured to:
in response to functional classification data for the design block identifier being in the data source, check a date stamp of the functional classification data for the design block identifier in the data source;
compare the date stamp of the functional classification data with a date stamp of corresponding circuit elements associated with the design block identifier in a netlist; and
if the date stamp of the functional classification data in the data source is older than the date stamp of the corresponding circuit elements associated with the design block identifier in the netlist, determine a functional classification of the plurality of circuit elements and update the functional classification data in the data source with the new functional classification data by storing in the data source and in association with the design block identifier, functional classification data indicative of the functional classification.

10. The interface of claim 1, wherein the application program callable function is further configured to, in response to a portion of the functional classification data for the design block identifier being in the data source and another portion of the functional classification data for the design block identifier not being in the data source, retrieve from a netlist a plurality of circuit elements associated with the portion of the functional classification data for the design block identifier that is not in the data source, determine a functional classification of the plurality of circuit elements and store, in the data source and in association with the design block identifier, functional classification data indicative of the functional classification.

11. The interface of claim 1, further comprising another application program callable function configured to:
in response to an API call from a user tool that specifies a design block identifier and updated circuit design data for updating circuit design information stored in a netlist associated with the design block identifier, overwrite the circuit design information stored in the netlist with the updated circuit design information.

12. A system for retrieving and processing circuit design data for use by a plurality of simulation tools, the system comprising:
a netlist storage arrangement configured for storing netlist information for a circuit design;
a functional classification data source configured for storing functional classification data in association with design block identifiers;
an interface configured to,
in response to an application programming interface (API) call from a simulation tool that specifies a design block identifier, search the functional classification data source for functional classification data associated with the design block identifier;
in response to functional classification data for the design block identifier not being in the functional classification data source, retrieve from the netlist storage arrangement a plurality of circuit elements associated with the design block identifier, determine a functional classification of the plurality of circuit elements and store, in the functional classification data source and in association with the design block identifier, functional classification data indicative of the functional classification; and
return functional classification data associated with the design block identifier to the simulation tool.

13. The system of claim 12, wherein the functional classification data source includes a data source at a simulation tool communicatively coupled with the interface, the interface being configured to search the data source at the simulation tool for the functional classification data in response to an API call from another simulation tool that specifies a design block identifier and, in response to the data source at the simulation tool having functional classification data associated with the specified design block identifier, to return the functional classification data associated with the design block identifier to the other simulation tool.

14. The system of claim 12, wherein the functional classification data source includes data sources at a plurality of locations, wherein the interface is configured to search the data sources at the plurality of locations for the functional classification data in response to the API call.

15. The system of claim 12, wherein at least some of the functionality of the interface is integrated with a simulation tool configured to interface with other simulation tools.

16. A method for retrieving and processing circuit design data for use by a plurality of simulation tools, the method comprising:
in response to an application programming interface (API) call from a simulation tool that specifies a design block identifier, searching a data source for functional classification data associated with the design block identifier;
in response to functional classification data for the design block identifier not being in the data source, retrieving from a netlist a plurality of circuit elements associated with the design block identifier, determining a functional classification of the plurality of circuit elements and storing, in the data source and in association with the design block identifier, functional classification data indicative of the functional classification; and
returning functional classification data associated with the design block identifier to the simulation tool.

17. The method of claim 16, wherein determining a functional classification of a combination of the plurality of circuit elements includes identifying the combination as making up a particular functional circuit and assigning a property to the combination that characterizes the particular functional circuit.

18. The method of claim 16, wherein determining a functional classification of a combination of the plurality of circuit elements includes accessing functional classification data that describes a functional classification of selected combinations of circuit elements and functionally classifying the retrieved circuit elements as a function of the accessed functional classification data.

19. The method of claim 18, wherein functionally classifying the retrieved circuit elements as a function of the accessed functional classification data includes functionally classifying the retrieved circuit design data by comparing a combination of the retrieved circuit elements with classified combinations of circuit elements and, upon finding a match between the combination of the retrieved circuit elements and a particular classified combination of circuit elements, determining the functional classification of the combination of the retrieved circuit elements by classifying the combination of retrieved circuit elements with the classification of the matching classified combination of circuit elements.

20. The method of claim 16, wherein retrieving from a netlist a plurality of circuit elements associated with the design block identifier includes associating ones of the plurality of circuit elements with a functional circuit and wherein determining a functional classification of the plurality of circuit elements includes determining a functional classification of the functional circuit.

21. The method of claim 16, wherein returning functional classification data associated with the design block identifier to the simulation tool includes returning functional classification data stored in the data source.

22. The method of claim 16, wherein searching a data source for functional classification data associated with the design block identifier includes:
in response to the data source including the functional classification data, checking a date stamp of the functional classification data;
comparing the date stamp of the functional classification data with a date stamp of corresponding circuit elements associated with the design block identifier in a netlist; and
if the date stamp of the functional classification data in the data source is older than the date stamp of the corresponding circuit elements associated with the design block identifier in the netlist, determine a functional classification of the plurality of circuit elements and update the functional classification data in the data source with the new functional classification data by storing in the data source and in association with the design block identifier, functional classification data indicative of the functional classification.

23. The method of claim 16, in response to a portion of the functional classification data for the design block identifier being in the data source and another portion of the functional classification data for the design block identifier not being in the data source, further comprising:
retrieving from a netlist a plurality of circuit elements associated with the portion of the functional classification data for the design block identifier that is not in the data source;
determining a functional classification of the plurality of circuit elements; and
storing, in the data source and in association with the design block identifier, functional classification data indicative of the functional classification.

24. The method of claim 16, further comprising:
in response to an API call from a user tool that specifies a design block identifier and updated circuit design data for updating circuit design information stored in a netlist associated with the design block identifier, overwriting the circuit design information stored in the netlist with the updated circuit design information.

25. A program storage device, comprising:
a processor-readable medium configured with instructions executable by the processor for demoting a page in virtual memory by performing the operations of:
in response to an application programming interface (API) call from a simulation tool that specifies a design block identifier, searching a data source for functional classification data associated with the design block identifier;
in response to functional classification data for the design block identifier not being in the data source, retrieving from a netlist a plurality of circuit elements associated with the design block identifier, determining a functional classification of the plurality of circuit elements and storing, in the data source and in association with the design block identifier, functional classification data indicative of the functional classification; and
returning functional classification data associated with the design block identifier to the simulation tool.

26. The device of claim 25, wherein the processor-readable medium is further configured with instructions executable by the processor for demoting a page in virtual memory by performing the operations of determining a functional classification of a combination of the plurality of circuit elements by identifying the combination as making up a particular functional circuit and assigning a property to the combination that characterizes the particular functional circuit.

27. The device of claim 25, wherein the processor-readable medium is further configured with instructions executable by the processor for demoting a page in virtual memory by performing the operations of determining a functional classification of a combination of the plurality of circuit elements by accessing functional classification data that describes a functional classification of selected combinations of circuit elements and functionally classifying the retrieved circuit elements as a function of the accessed functional classification data.

28. The device of claim 27, wherein the processor-readable medium is further configured with instructions executable by the processor for demoting a page in virtual memory by performing the operations of functionally classifying the retrieved circuit elements as a function of the accessed functional classification data by functionally classifying the retrieved circuit design data by comparing a combination of the retrieved circuit elements with classified combinations of circuit elements and, upon finding a match between the combination of the retrieved circuit elements and a particular classified combination of circuit elements, determining the functional classification of the combination of the retrieved circuit elements by classifying the combination of retrieved circuit elements with the classification of the matching classified combination of circuit elements.

29. The device of claim 25, wherein the processor-readable medium is further configured with instructions executable by the processor for demoting a page in virtual memory by performing the operations of:
retrieving from a netlist a plurality of circuit elements associated with the design block identifier by associating ones of the plurality of circuit elements with a functional circuit; and
determining a functional classification of the plurality of circuit elements by determining a functional classification of the functional circuit.

30. A method for storing and processing circuit design data, the method comprising:
in response to a first simulation tool request for access to information regarding a component of a circuit design, retrieving and processing information regarding the circuit design component;
storing the processed information in a format that is amenable to simulation;
returning at least a portion of the processed information to the simulation tool; and
in response to a second simulation tool request for access to information regarding the circuit design component, returning at least a portion of the stored information regarding the circuit design component.

31. A system for storing and processing circuit design data, the system comprising:
means for retrieving and processing information regarding a component of a circuit design in response to a first simulation tool request for access to information regarding the circuit design component;
means for storing the processed information in a format that is amenable to simulation;
means for returning at least a portion of the processed information to the simulation tool; and
means for returning at least a portion of the stored information regarding the circuit design component in response to a second simulation tool request for access to information regarding the circuit design component.

32. A system for retrieving and processing circuit design data for use by a plurality of simulation tools, the system comprising:
means for searching a data source for functional classification data associated with a design block identifier in response to an application programming interface (API) call from a simulation tool that specifies the design block identifier;
means, responsive to functional classification data for the design block identifier not being in the data source, for retrieving from a netlist a plurality of circuit elements associated with the design block identifier, determining a functional classification of the plurality of circuit elements and storing, in the data source and in association with the design block identifier, functional classification data indicative of the functional classification; and
means for returning functional classification data associated with the design block identifier to the simulation tool.
